(19) United States
(12) Patent Application Publication
(10) Pub. No.: US 2009/0144270 A1
(43) Pub. Date: Jun. 4, 2009

(54) METHODS FOR THE PREVENTION OF DISEASES

(76) Inventors: Jack Thacher Leonard, South Hamilton, MA (US); Rudolph Patrick Pizzano, South Hamilton, MA (US)

Correspondence Address: BARLOW, JOSEPHS & HOLMES, LTD., 101 DYER STREET, 5TH FLOOR, PROVIDENCE, RI, 02903, US

(21) Appl. No.: 12/325,163

(22) Filed: Nov. 29, 2008

Related U.S. Application Data
(60) Provisional application No. 61/004,645, filed on Nov. 29, 2007.

(51) Int. Cl. G06F 7/06; G06F 17/30

(52) U.S. Cl. 707/5; 707/E17.014

(57) ABSTRACT

A method of matching candidates with a user based upon, in part, on genetic factors including the following steps. First, a database is maintained including one or more of candidates having personal profiles. Next, a personal profile of a user is compared with the personal profiles of the candidates in the database for purposes of social compatibility. A set of candidates is generated which are socially compatible with the user. The personal profile of the user is then compared with each of the personal profiles of the generated set of candidates. The risk of the user producing offspring having a disease with each of the candidates within the generated set is determined. Finally, a user is presented with the set of candidates along with the determination of the risk of the user and selected candidate producing offspring having a disease.

### CROSS REFERENCE TO RELATED APPLICATION

This application is related to and claims priority from earlier filed provisional patent application Ser. No. 61/004,645, filed Nov. 29, 2007 and incorporated herein by reference.

### BACKGROUND OF THE INVENTION

The present invention generally relates to methods for prevention of diseases and, in particular, methods for prevention of diseases using genetic screening. More specifically, the present invention relates to a new methods for prevention of diseases which uses genetic screening and protects the medical privacy of individuals. Also, the methods for prevention of diseases using genetic screening provides a cost-effective way of reducing the risk of individuals having offspring with diseases.

Reproductive success can be measured by the ability to produce children who mature to become healthy adults. Early intervention ensures the highest likelihood of preventing these serious genetic diseases. The internet provides a means of identifying prospective mates by matching individuals based social compatibility factors such as location, age, appearance, educational background, personality traits, hobbies, and other preferences, as disclosed in U.S. Pat. No. 5,963,951 in U.S. Pat. No. 7,085,806. Social networking and dating activities on the Internet provide a unique opportunity to prevent carriers of the same genetic disease from ever being introduced to one another while simultaneously preserving their medical privacy. However, there is no convenient way to confidentially and anonymously match prospective mates based on their genetic compatibility.

By definition, autosomal recessive traits are inconsequential to heterozygotes (i.e., carriers), but tragic for homozygotes and their families. Since carriers of AR disease have no apparent symptoms, their carrier status usually remains unknown unless they have an affected child or relative. There can be a stigma attached to asymptomatic genetic defects (see Committee on Bioethics. (2001). Ethical Issues With Genetic Testing in Pediatrics. Pediatrics 107:1451-1455) despite that 10-15% of the American population is a carrier for at least one of the following serious AR diseases (cystic fibrosis, alpha-1-antitrypsin deficiency, alpha-thalassemia, beta-thalassemia, sickle cell anemia, phenylketonuria, Tay-Sachs, or Gaucher).

The likelihood that an American child is born afflicted by one of these AR diseases is approximately 0.27% (one per 368 births). The aggregate risk for genetic disease in the general population is significantly higher than for any one disease. Tay-Sachs disease had an incidence of 1/3,600 newborns in Ashkenazi couples prior to the implementation of a successful carrier screening program. (see Layton, M. (2006). Love v. Science? Worldwide program aims to eradicate Jewish birth defect. Jewish World Review. Feb. 14, 2006)

The mutations underlying these debilitating AR diseases have been known for several years. Molecular genetic testing is conducted using one or a combination of the following techniques: DNA Sequencing, multiplex polymerase chain reaction (PCR), microsatellite, short tandem repeat (STR), or microarray analysis, or TaqMan genotyping assays (Applied Biosystems). Due to a high cost clinical delivery model, restrictive state laws, ethical considerations and lack of consumer education, genetic testing and counseling is now limited to a small population of married couples and pre-married couples in close ethnic and religious communities in which genetic abnormalities are more common.

As dating couples grow more emotionally attached, it becomes increasingly difficult for them to make medically-driven reproductive decisions. The range of the actions considered could include termination of a relationship, birth control, adoption, preimplantation genetic diagnosis, amniocentesis, or abortion.

Through the efforts of Dor Yeshorim in the Jewish community and other genetic screening programs, the incidence of live births of Tay-Sachs babies has been reduced by about 90 percent in the United States and Canada since the 1970s. Dor Yeshorim keeps genetic testing information confidential until couples who are considering marriage or starting a family, request an analysis of their genetic compatibility. Each person who is screened receives an identification number but is not told the results of the screening process. Instead, they are encouraged to call the service to “check each prospective match at the earliest stage possible,” assuming that the prospective mate has been tested as well. To determine the risk for genetic disorders, each person provides their ID number and date of birth and receives word as to whether the couple is compatible, considering these disorders. Compatibility may indicate that neither is a carrier or that only one is a carrier; the couple is not told which the case is. However, if they are both carriers of the same disease, they will be informed of that and offered counseling. When they are notified that they are incompatible, both individuals are effectively deprived both of their medical privacy by disclosure to the other individual and of their “right not to know” about their own carrier status.

The following paragraphs list examples of a category of genetic diseases, called Autosomal Recessive Diseases, which may be prevented using the methods outline for the present invention. Cystic Fibrosis (CF) affects many organs in the body: especially the lungs, pancreas and sweat glands. A build-up of thick, sticky mucus in the lungs leads to respiratory problems. Fifty percent of CF patients only live into their late 30's. It affects 1/3,200 newborns of various ethnicities each year. (See Rosenstein B J and Cutting G R (1998) The diagnosis of cystic fibrosis: a consensus statement. Cystic Fibrosis Foundation Consensus Panel. J. Pediatr. 132:589-95) Approximately 1/30 individuals in the general population are carriers for CF.

Alpha-1 Antitrypsin (AAT) Deficiency— 1/500 newborns are affected and 1/13 individuals are AAT deficiency carriers.³ The impression that AAT deficiency is a rare disease has resulted in infrequent orders for tests for by physicians. AAT deficiency is not rare but actually may be one of the most common single-locus diseases in the world. The clinical manifestations of AAT deficiency vary widely among individuals, ranging from asymptomatic in some individuals, to fatal liver or lung disease in others. Homozygotes of Pi type Z (PiZ allele) have only 10 to 20 percent of the normal serum AAT concentration, and have a high risk of developing pulmonary emphysema. AAT is an inhibitor of serine proteases, the unopposed action of which may damage the lung and other organs. Smoking or exposure to tobacco smoke increases the appearance of symptoms and damage to the lungs. Other common diagnoses include COPD (chronic obstructive pulmonary disease), asthma, chronic bronchitis and bronchiectasis—a chronic inflammatory or degenerative condition of one or more bronchi or bronchioles. Neonatal hepatitis occurs in 10 to 20 percent of AAT deficient homozygotes, and cirrhosis develops in a number of them in later childhood or in adult life. (See Hutchinson, D.C. 1988. Natural history of alpha-1-protease inhibitor deficiency. Am. J. Med. 84:3-12)

Hemoglobinopathies resulting from mutations in the alpha- or beta-like globin clusters are the most common inherited disorders in humans, with 7% of the world population being carriers of one of the following globin gene mutations.

Alpha Thalassemia affects 1/15,000 newborns in the United States. (See http://www.dhs.ca.gov/pcfh/gdb/html/NBS/ProgrOVforParents.htm#HowCommonRDisordersCA) The deletion of three of the four alpha globin genes produces a serious hematological problem. This form of alpha thalassemia is called HbH disease. Patients with this condition have a severe anemia, and often require blood transfusions to survive. The affected individuals have moderate to severe lifelong hemolytic anemia, modest degrees of ineffective erythropoiesis, splenomegaly, and variable bony changes. Untreated, most patients die in childhood or early adolescence.

The loss of all four alpha globin genes produces a form of the disease known as alpha thalassemia major, or hemoglobin Bart. Most fetuses with alpha thalassemia major die in utero or shortly after birth. Rarely, hemoglobin Bart has been detected in utero, usually in a family where the disorder occurred in an earlier child. In utero blood transfusions have saved some of these children. These patients require life-long transfusions and other medical support.

Beta Thalassemia which impacts 1/27,000 newborns are characterized by reduced or absent synthesis of hemoglobin A, and results in severe anemia within the first year of life. Regular and frequent blood transfusions in the first decade allow for quasi-normal growth and development in childhood, although iron storage secondary to the transfusion regimen becomes clinically apparent in the second decade of life. Despite continuous supportive treatment, including daily chelation therapy to remove excess iron, beta-thalassemia disease is debilitating and life-threatening even in individuals who have achieved a negative iron balance. Death occurs in the second or third decade of life. (See Ostrowsky, J T, Lippman, A, and Scriver, C R. 1985. Cost-benefit Analysis of a Thalassemia Disease Prevention Program. Am. J. Public Health 75: 732-736.)

Sickle Cell Anemia impacts 1/4,400 newborns. More than 50,000 Americans currently suffer from sickle cell disease. Primarily, morbidity in sickle cell disease arises form vaso-occlusive events or tissue damage resulting from obstructed blood flow. Some of the more common symptoms include pain crises, acute chest syndrome, cerebrovascular accidents, and splenic and renal dysfunction. (See Ashley-Koch, A, Yang, Q. and Olney, R. S. 2000. Sickle hemoglobin (Hb S) Allele and Sickle Cell Disease: A HuGE Review. Am. J. Epidemiol. 151:839-845) The median survival for individuals with sickle cell anemia is 42 and 48 years, respectively, for males and females. (See Platt O S, Brambilla D J, Rosse W F, et al. 1994. Mortality in sickle cell disease: life expectancy and risk factors for early death. N. Engl. J. Med. 330:1639-44)

Phenylketonuria (PKU) is detected in 1/27,000 newborns. Untreated children are normal at birth, but fail to attain early developmental milestones, develop microcephaly, and demonstrate progressive impairment of cerebral function. Hyperactivity, EEG abnormalities and seizures, and severe mental retardation are major clinical problems later in life. In contrast, affected children who are detected at birth and treated by following a special diet low in phenylalanine for the rest of their life are less likely to develop neurological problems and have seizures and mental retardation, though such clinical disorders are still possible. See (http://www.genetests.org/servlet/access?db=geneclinics&site=gt&id=8888891&key=BmEj23vktY7qt&gry=&gen=y&gw=uQt3&filename=/profiles/pku/index/html)

Tay-Sachs is a neurodegenerative condition most common among Ashkenazi Jews where apparently healthy babies at about 6 months of age lose already acquired skills, gradually become blind, paralyzed and unaware of their surroundings and usually die before 5 years of age. The frequency of Tay-Sachs in the Ashkenazi Jewish population was 1/3,600 newborns prior to the implementation of an aggressive carrier screening program, and the carrier frequency is 1/30. (See Petersen G M, Rotter J I, Cantor R M, et al. (1983) The Tay-Sachs disease gene in North American Jewish populations: geographic variations and origin. Am J Hum Genet. 35:1258-1269.) In the general population, it is estimated to affect 1/360,000 newborns with a 1/275 carrier frequency. (See http://www.genetests.org/query?dz=tay-sachs)

The signs and symptoms of Gaucher disease vary widely among affected individuals. The major features of this disorder include enlargement of the liver and spleen (hepatosplenomegaly), a low number of red blood cells (anemia), easy bruising caused by a decrease in blood platelets (thrombocytopenia), and bone disease. Gaucher disease can also affect the heart and lungs. The features of this disorder range from mild to severe and may appear early in life or in adulthood. (see Meikle P J, Hopwood J J, Clague A E, Carey W F. (1999) Prevalence of lysosomal storage disorders. JAMA 281:249-54) There are 1/57,000 newborns with Gaucher in the general population.

The subtypes of Gaucher disease are grouped by their signs and symptoms. Type 1 Gaucher disease causes liver and spleen enlargement, bone pain and broken bones, and, sometimes, lung and kidney problems. Type 1 is the most common form affecting both children and adults and is most prevalent in the Ashkenazi Jewish population, affecting anywhere from 1/855 newborns with a 1/18 carrier frequency.

Types 2 and 3 Gaucher disease are known as neuronopathic forms of the disorder because they are characterized by problems that affect the nervous system. In addition to the signs and symptoms described above, these conditions can cause seizures and brain damage. Type 2 Gaucher disease usually causes severe brain damage. Most children who have Type 2 die by age 2. Type 3 Gaucher disease also affects the nervous system, but tends to progress more slowly than Type 2.

Therefore, there remains a need in the prior art for a method for prevention of diseases using genetic testing that protects the medical privacy of the tested individuals. More importantly, a method that determines the genetic compatibility of two individuals while maintaining the confidentiality and anonymity of each individual's genetic profile. Also, a method there remains a need for a method which prevents diseases using genetic testing at a reasonable cost.

### BRIEF SUMMARY OF THE INVENTION

The present invention generally relates to methods for prevention of diseases and, in particular, methods for prevention of diseases using genetic screening. More specifically, the present invention relates to a new methods for prevention of diseases which protects the medical privacy of individuals. Also, the methods for prevention of diseases provides a cost-effective way of reducing the risk of individuals having offspring with diseases.

A method of matching candidates with a user based upon, in part, on genetic factors including the following steps. First, a database is maintained including a one or more candidates having personal profiles. To maintain a database on the candidates, information is collected for a candidate related to social factors used in a personal profile. Also, information is collected related to genetic factors used in determination of risk for the candidate producing offspring with disease for updating a personal profile for the candidate. The information for genetic factors may be collected by compiling information concerning a testing of DNA sample from the candidate and questionnaire directed to genetic and hereditary history for the candidate. Once the information is collected, a personal profile is created for the candidate based upon social factors and genetic factors. Throughout the method of the present invention, the information concerning genetic factors of a user or candidate is not disclosed to the user or the candidate.

Next, a personal profile of a user is compared with the personal profiles of the candidates in the database for purposes of social compatibility. A set of candidates is generated which are socially compatible with the user. The personal profile of the user is then compared with each of the personal profiles of the generated set of candidates. The risk of the user producing offspring having a disease with each of the candidates within the generated set is determined. The candidates having unacceptable risk of user and said candidate producing offspring having a disease are eliminated before user views the set of candidates. In one embodiment, a composite compatibility score for the user and candidate is determined to represent the risk of the user and the candidate having offspring with a disease. Finally, a user is presented with the set of candidates along with the determination of the risk of the user and selected candidate producing offspring having a disease.

It is therefore an object of the embodiment to increase social acceptance of genetic screening to prevent disease.

It is a further object of the embodiment to provide methods for preventing disease using genetic screening which protects the medical privacy of users and candidates.

Another object of the embodiment is to provide methods for preventing disease using a composite compatibility score which protects the medical privacy of users and candidates.

An additional object of the embodiment is to provide methods for preventing disease using genetic testing which is cost-effective.

Other objects, features and advantages of the invention shall become apparent as the description thereof proceeds when considered in connection with the accompanying illustrative drawings.

### BRIEF DESCRIPTION OF THE DRAWINGS

The novel features which are characteristic of the improved methods for prevention of diseases are forth in the appended claims. However, the methods for prevention of diseases, together with further embodiments and attendant advantages, will be best understood by reference to the following detailed description taken in connection with the accompanying drawings in which:

FIG. 1 is a chart outlining definitions of key terms for the present invention;

FIG. 2 is a chart displaying example whereby genetic testing information is incorporated into online dating services for anonymous compatibility screening.

FIG. 3 is a flow diagram outlining the steps for a cost-effect method for determining genetic compatibility; and

FIG. 4 is a flow diagram outlining the steps of an embodiment of the present invention.

### DETAILED DESCRIPTION OF THE PREFERRED EMBODIMENTS

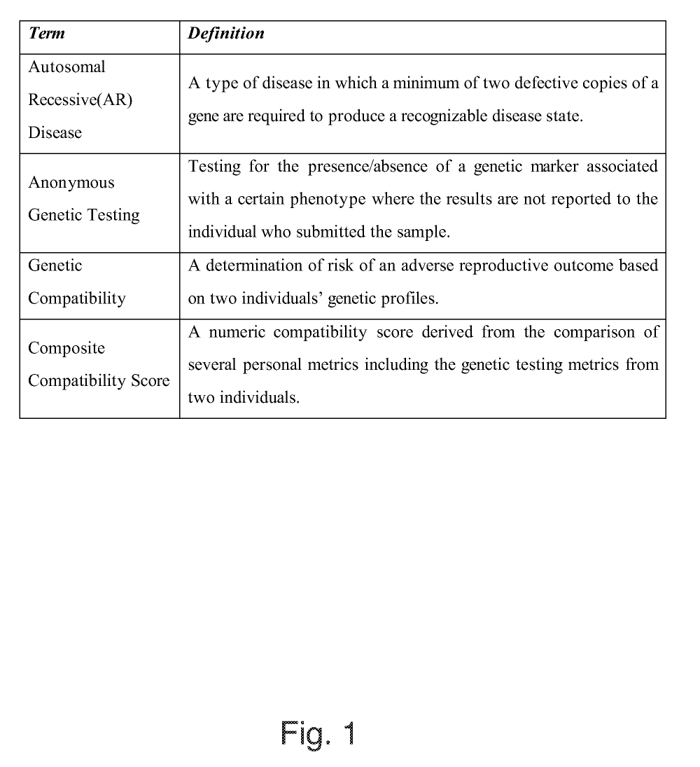

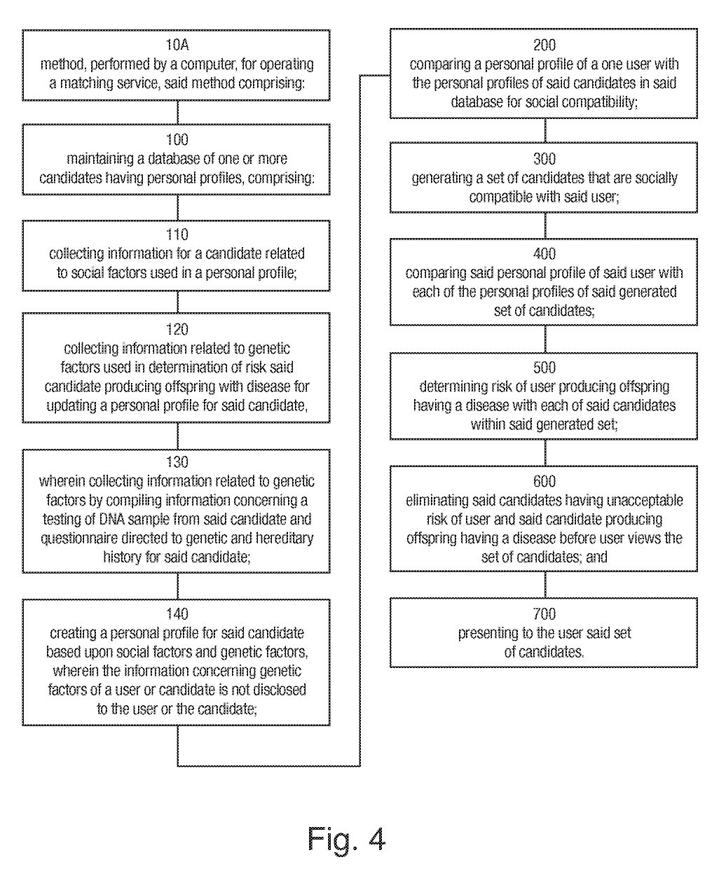

In accordance with the present invention, as shown in FIGS. 1-4, new methods 1OA for prevention of diseases using genetic screening is provided. More specifically, the present invention relates to a new methods for prevention of diseases which protects the medical privacy of individuals. Also, the methods for prevention of disease provides a cost-effective way of reducing the risk of individuals having offspring with diseases. Note, FIG. 1 is incorporated herein to provide definitions to commonly used terms.

A method of matching candidates 10A with a user based upon, in part, on genetic factors including the following steps. First, a database is maintained 100 including a one or more candidates having personal profiles. To maintain a database on the candidates, information is collected 110 for a candidate related to social factors used in a personal profile. U.S. Pat. No. 6,735,568, assigned to eHarmony.com, discloses the usage of social factors in a personal profile to assist in determining social compatibility of candidates and users and is incorporated herein by reference.

Also, information is collected related to genetic factors 120 used in determination of risk for the candidate producing offspring with disease for updating a personal profile for the candidate. The information for genetic factors may be collected by compiling information 130 concerning a testing of DNA sample from the candidate and questionnaire directed to genetic and hereditary history for the candidate. Once the information is collected, a personal profile 140 is created for the candidate based upon social factors and genetic factors. Throughout the method of the present invention, the information concerning genetic factors of a user or candidate is not disclosed to the user or the candidate.

Next, a personal profile of a user is compared with the personal profiles of the candidates 200 in the database for purposes of social compatibility. A set of candidates is generated which are socially compatible with the user 300. The personal profile of the user is then compared with each of the personal profiles of the generated set of candidates 400. The risk of the user producing offspring having a disease with each of the candidates within the generated set is determined 500. The candidates having unacceptable risk of user and said candidate producing offspring having a disease are eliminated before user views the set of candidates 600. In one embodiment, a composite compatibility score for the user and candidate is determined to represent the risk of the user and the candidate having offspring with a disease. Finally, a user is presented with the set of candidates along with the determination of the risk of the user and selected candidate producing offspring having a disease 700.

The present inventor describes a method of determining genetic compatibility anonymously that could decide whether individuals seeking relationships are introduced through social networking or online dating websites. Single individuals who have been genetically tested can anonymously match their encrypted DNA profile against encrypted profiles of others. Unlike the Dor Yeshorim protocol (described above), Internet users need not know their own genetic profile (e.g., carrier status) upon determination of genetic incompatibility with another individual's genetic profile. With the advent of the Internet and availability of genetic testing for several AR diseases, one could decide whether they are only introduced to individuals where their probability of having a healthy child is high. This does not require that they reveal their genetic profile to anyone else, nor will it reveal anyone else's profile to them, nor does any person with privileged medical knowledge or community influence need to serve as matchmaker.

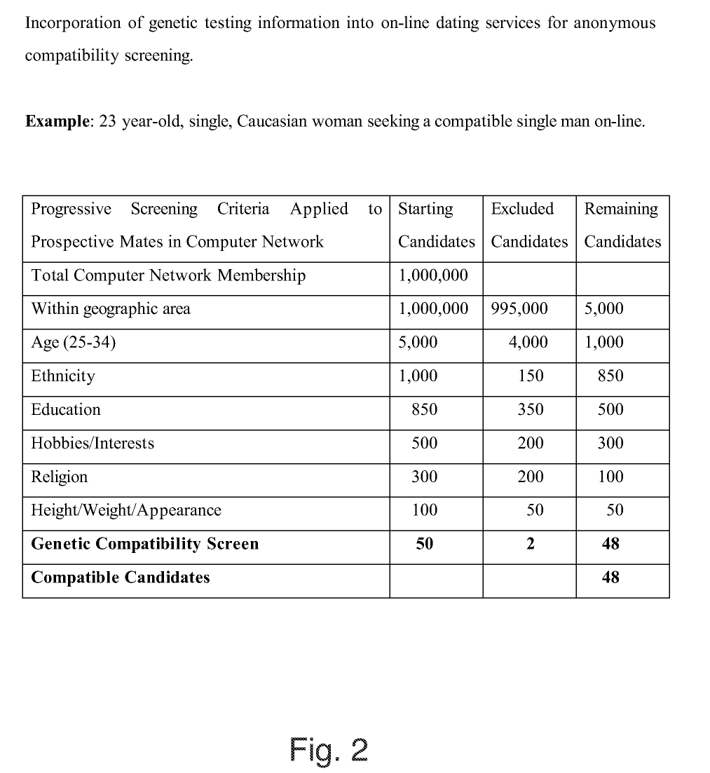

FIG. 2 illustrates how genetic information is incorporated into anonymous compatibility screening in an on-line dating scenario. Starting with a population of approximately 1,000,000 individuals that are within a reasonable distance, the candidates are successively filtered based on user-defined compatibility criteria. The Anonymous Compatibility Screen would further reduce the number of suitable candidates.

According to FIG. 2, two out of 50 males that met the other matching criteria were automatically eliminated as candidates because they were carriers of the same genetic defect as the woman conducting the search. The woman would be unaware whether anyone was eliminated from her search on the basis of their genetic incompatibility, and additionally she couldn't know that she was a carrier unless she chose to undergo additional genetic testing and counseling supervised by licensed medical professionals.

This anonymous, automated method of determining genetic compatibility achieves the following objectives: protects the privacy of individual genetic profiles; does not require that people are diagnosed or aware of their own genetic profile in order to prevent disease which removes any possible stigma or obligation of disclosure otherwise associated with carrier status; prevents the unintentional pairing of carriers for the same genetic disease by on-line dating or social networking companies; and eliminates the medical and psychological burden of preventable genetic diseases on individuals, families and society.

The method for prevention of disease can also determine the risk of an autosomal recessive disease in offspring of a user and candidate using genetic screening. Autosomal diseases are selected from a group consisting of: cystic fibrosis, alpha-1 antitryspin (AAT) deficiency, hemoglobinopathies, alpha thalassemia, beta thAlassemia, sickle cell anemia, phenylketonuria (PKU), Tay-Sachs, or Gaucher. In one embodiment, the personal profile of the user is compared to the personal profile of the candidate. The candidates are then eliminated from the set of candidates if the personal profile of said user and the personal profile of said candidate identifies both said user and said candidate as carriers for at least one of the same autosomal recessive diseases

It is more challenging to administer an anonymous genetic screen to couples already in a relationship that may result in marriage and/or pregnancy. To protect the privacy of such couples, they would separately complete a detailed, confidential personal and family medical history questionnaire before genetic testing. If the composite score results derived from the questionnaire and subsequent genetic testing didn't achieve a minimum threshold value, the couple would be notified. If they still wished to proceed despite the low composite score, the couple would be referred to a medical professional along with all the results for analysis and counseling.

Recent developments have generated increased interest in genetic testing in the general population. More than 200,000 consumers have participated in the National Geographic Society/IBM DNA testing program which determines ancestral migration patterns. Lower cost testing technologies are available which present the opportunity to make genetic prescreening of the general population for genetic disorders economically feasible. In a genetic prescreen, there may be limited or no family history of genetic disorders available, so that a Bayesian analysis of prior carrier status probabilities is not feasible; all information is garnered from the DNA testing.

The total benefits from genetic testing must exceed the costs to be economically feasible. Some of the benefits, such as healthcare cost avoidance, are easy to quantify. Others, such as quality of life, are not. There are two types of costs in conducting a genetic testing program. There are fixed capital costs for the genetic testing equipment and variable costs for reagents, laboratories supplies and labor for each test. Annual fixed costs are typically calculated using the total fixed costs and then applying an annual interest rate that reflects the cost of capital.

Therefore, the feasibility equation for conducting a testing program for a year is: (Equation 1) Excess Benefits=Total Benefits−Variable Costs−(Cost of Capital*Fixed Costs) If the Excess Benefits are greater than zero, then the genetic program is economically feasible.

Fixed costs are sunk costs, in that they can not be recovered. Post-investment, maximizing total benefits less variable costs will maximize excess benefits. Therefore, an optimal testing strategy maximizes benefits minus variable costs.

Each genetic disorder can be represented by a set of alleles. Some diseases may have as few as 2-3 associated alleles; others may have hundreds of disease-associated alleles. Each allele requires a separate test, so that it costs 10 times as much to test for 20 alleles as it does to test for 2 alleles. The genetic markers vary in prevalence within the population. As an allele becomes rarer, the probability of identifying a couple where at least one individual has the rare allele decreases. Therefore, the rarer alleles have a lower benefit to cost relationship.

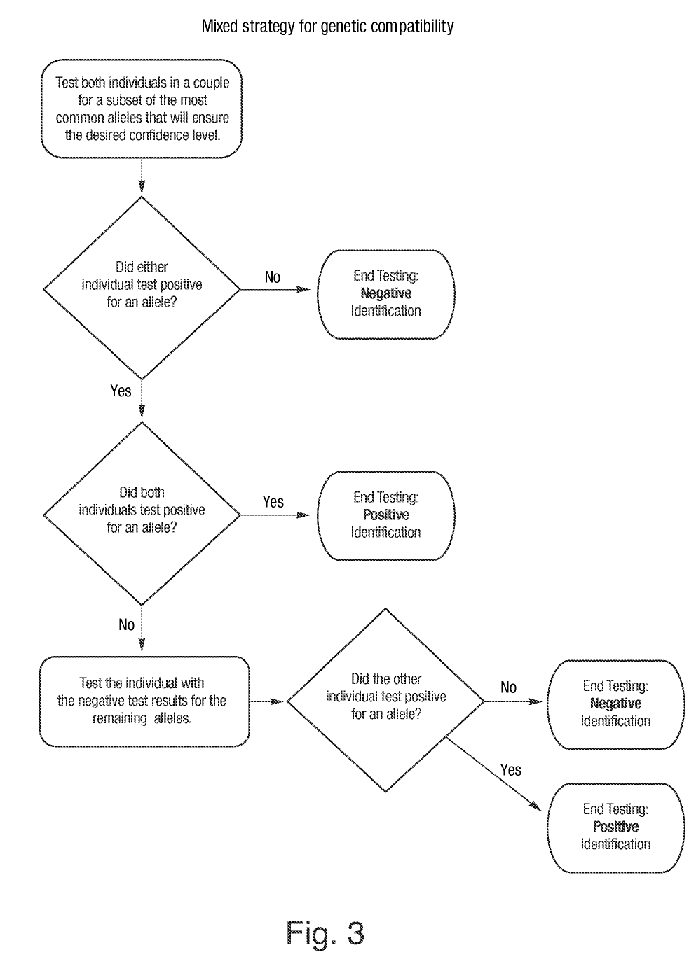

One strategy would examine a fixed number of genetic markers for each individual for a disorder. This would equalize the cost per disorder. However, it would lead to varying probabilities that each disorder would be detected. The detection probability may also not meet societal standards for an effective test. A second strategy would test all markers on every man (woman) and then just test the carriers with their paired women (men). A third strategy, illustrated in FIG. 3, is a mixed strategy that combines the strengths of the first two strategies. In this mixed strategy, each individual member of a couple would be tested for a fixed number of the most common alleles. If both couples have an allele, a case is identified. If neither individual has an allele, testing ceases. If one individual has an allele, then the other individual is fully tested for all remaining alleles. In this strategy, the probability of identifying a disorder is high, as only couples who both have among the rarest genetic alleles would be missed. Therefore, the minimum accuracy can be set at a uniform level across disorders, (e.g. 98%) and then the number of alleles that both can be tested for can be selected based on a benefit cost calculation.

Now that the algorithm has been outlined, the two optimal parameters that need to be defined to optimize the algorithm are: 1) the confidence interval of the test, 2) the subset of most common alleles (n) of total allele tests (N) which will be included in the primary testing which is done with both individuals. This confidence interval for the test can be selected a priori based on societal norms. Once the confidence interval is selected, then the primary testing subset n can be selected by maximizing the benefits of testing less the variable costs over all possible values for n. Mathematically, this can be expressed as solving the following optimization problem:

Max(B*J)−(C*(U+V)) [Equation 2]:

n

n subject to J/((P̂2)*(I/2))>k, (preselected confidence interval) and,

N>=n>=0

### Where:

n=the number of the most common alleles in the primary testing subset
N=the total number of alleles for the disorder
N−n=the number of the least common alleles in the secondary testing subset
I=number of total individuals tested
I/2=number of couples tested
P=prevalence of the disorder in the general population, including all variations
J=number of cases identified by the process by the primary testing of the subset n or the secondary testing of the remaining alleles (N−n)
B=benefits per case identified
C=cost of testing one individual for one allele
U=number of tests conducted in the primary screen of both individuals
V=number of tests conducted in the secondary screen of only the partners of a carrier.

This problem can be solved as an integer programming problem. However, the number of common alleles for a disorder is usually less than 25, so that exact enumeration of the value of the maximum for all alternatives is not a computationally intensive procedure. As an example, we use the following values for each of the variables:
98%=confidence level for carrier identification
25=the total number of known alleles for the disorder
20,000=number of total individuals tested
10,000=number of couples tested
4%=prevalence of the disorder in the general population, including all variations
$125,000=benefits per case identified
$2.00=cost of testing one individual for one allele.
   For purposes of comparison to the optimal solution, we calculate a base case from the strategy of testing all men (women) for all 25 alleles and then testing the women (men) paired with the carriers. With a 4% prevalence, 400 men out of 10,000 men would test positive as a carrier. Out of these 400 men, 4% or 16 women coupled with these men would also test positive. Therefore, the total benefits from testing would be 16×$125,000 or $2,000,000. The total costs would be $520,000. 10,000 individuals tested with 25 tests would require 250,000 tests at $2.00 to arrive at the cost of $500,000. 400 paired individuals with the carriers tested with 25 tests would require 10,000 tests at $2.00, adding $20,000 to the full cost of testing. Netting these costs out against the benefits results in a net benefit of $1,480,000.

To calculate the optimal value for n, we need to make assumptions about the relative prevalence of the 25 alleles. For this example, we assume that the allele prevalences, when ranked highest to lowest, follow an exponentially declining pattern.
S1=share of total prevalence by the most common allele
S2=share of total prevalence by the second most common allele
S25=share of total prevalence by the least common allele
D=Decay factor
S2=S1*D
Sn=S1*Dn−1
   In this case, we will set these parameters as follows:
0.40=share of total prevalence by the most common allele
0.60=Decay factor
   These parameter values result in the following values for S1, S2, S3 and S4:
0.40=share of total prevalence by the most common allele
0.24=share of total prevalence by the second most common allele
0.144=share of total prevalence by the third most common allele
0.0864=share of total prevalence by the fourth most common allele
   The cumulative share for the four most common alleles is 0.8704.
   We will compute the benefit-cost calculation for the example n=4, meaning that the primary screen will be for these four most common alleles. The primary screen will involve 80,000 tests—4 per individual.

In the primary screen, 348 men (0.04×0.8704×10,000) and 348 women will be identified as carriers. Of these 348 men, 12 of the paired women will be identified as carriers. These 12 couples will be identified as cases with a total benefit of $1,500,000 against testing costs of $160,000, resulting in a net benefit from the primary screen of $1,340,000 and a benefit/cost ratio of 9.4.

For the secondary screen, 336 men (348−12) and 336 women will be screened with the remaining 21 (N−n) tests. This results in a total of 14,112 tests. The only cases that could possibly be unidentified would be one with a combination of one of the least common alleles. The probability of this occurring is equal to (1−(S1+, S2+S3+S4))2 or 0.0168. This corresponds to a 98.32% identification rate, which exceeds the required rate of 98%. Applied to 16 cases, this would result in the expected identification of the remaining 4 cases, for total incremental benefits of $500,000. The testing costs would be $28,224, resulting in a net benefit from the secondary screen of $471,776 and a benefit/cost ratio of 17.7.

For the primary and secondary screen, the total benefits would be $2,000,000 against costs of $188,224, resulting in a net benefit of $1,811,776 and a benefit to cost ratio of 9.6.

Results are presented for all other possible subset selections. For values less than 4, the lower primary screen tests are not expected to identify all 16 cases. For values over 4, there is an additional cost of $40,000 for each allele test with no gain in the expected number of cases identified. Adjusting for the fractional gain in probability of identifying the last case, does not change the optimal results.

In comparison to the base case of testing all of one sex first with all 25 tests, the results are better for all values of n between 2 and 12 inclusively. The intuition behind this that even if you were to conduct half the number of total tests, it would be more valuable to selectively test for the most common alleles then test half the people.

It is important to note here that prevalences do not have to be exponentially declining for this mixed strategy model. Prevalences across sets of alleles are never exactly equal, and ranking them from highest to lowest always results in a declining relationship of some sort, whether it be a linear or nonlinear relationship. It is the slope of this line which determines the optimal subset. The steeper the decline, the fewer tests will be selected to be included in the optimal subset.

These genetic compatibility testing strategies could also be favorably applied to matching desirable autosomal recessive genetic traits such as resistance to infectious diseases or cancer.

A mixed testing strategy of testing for a subset of the most common alleles for a genetic disorder, and then testing the corresponding mate for the remaining rare alleles can, under circumstances where the alleles exhibit exponentially declining prevalences, produce optimal net benefits from genetic testing at high confidence intervals.

It should be noted the method of the present invention 10A may be performed by a computer, network or in a system. The system may include a network providing communication between the matching service and one or more remote units. The network may also provide communication between the matching service and one or more secure servers. In some embodiments, the remote unit and the secure server are the same device. For example, the remote unit may be, but are not limited to, a computer, cellular device, telephone, personal digital assistant, or any other device capable of interfacing with a network. Networks for communication between the server and the remote units include, but are not limited to, the internet, an intranet, an extranet, a virtual private network (VPN) and non-TCP/IP based networks.

Also, as described above, some embodiment of the present invention may include software routines that perform analysis to match genetically compatible users and candidates.

In view of the foregoing, a new methods for prevention of diseases using genetic screening is provided. More specifically, the present invention relates to new methods for prevention of diseases which protects the medical privacy of individuals. Also, the methods for prevention of diseases provides a cost-effective way of reducing the risk of individuals having offspring with diseases.

Therefore, while there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method of matching candidates with a user, comprising:
maintaining a database of one or more candidates having personal profiles;
comparing a personal profile of a user with the personal profiles of said candidates in said database for social compatibility;
generating a set of candidates that are socially compatible with said user;
comparing said personal profile of said user with each of the personal profiles of said generated set of candidates;
determining risk of user producing offspring having a disease with each of said candidates within said generated set; and
presenting to the user said set of candidates along with said determination of the risk of user and selected candidate producing offspring having a disease.

2. The method of claim 1, wherein maintaining said database comprises:
collecting information for a candidate related to social factors used in a personal profile;
collecting information related to genetic factors used in determination of risk of said candidate producing offspring with disease for updating a personal profile for said candidate; and
creating a personal profile for said candidate based upon social factors and genetic factors.

3. The method of claim 2, wherein collecting information related to genetic factors comprises:
compiling information concerning a testing of DNA sample from said candidate and questionnaire directed to genetic and hereditary history for said candidate.

4. The method of claim 2, wherein the information concerning genetic factors of a user or candidate is not disclosed to either the user or the candidate.

5. The method of claim 1, wherein said candidates having unacceptable risk of user and selected candidate producing offspring having a disease are eliminated before user views the set of candidates.

6. The method of claim 1, wherein the disease is an autosomal recessive disease.

7. The method of claim 6, wherein the autosomal recessive diseases are selected from a group consisting of: cystic fibrosis, alpha-1 antitryspin (AAT) deficiency, hemoglobinopathies, alpha thalassemia, beta thalassemia, sickle cell anemia, phenylketonuria (PKU), Tay-Sachs, or Gaucher.

8. The method of claim 7, further comprising:
comparing the personal profile of said user to the personal profile of said candidate; and
eliminating candidates from said set of candidates if the personal profile of said user and the personal profile of said candidate identifies both said user and said candidate as carriers for at least one of the same autosomal recessive diseases.

9. The method of claim 3, wherein the testing of the DNA sample for each candidate comprises:
selecting at least one predetermined disease;
identifying a set of alleles correlating to at least one of the predetermined diseases;
testing the DNA sample for the set of alleles for at least one of the predetermined diseases.

10. The method of claim 9, wherein the number of alleles tested for each predetermined disease is determined using the following algorithm:
Max(B*J)−(C*(U+V))
n
n subject to J/((P̂2)*(I/2))>k, (preselected confidence interval) and,
N>=n>=0
n=the number of the most common alleles in the primary testing subset
N=the total number of alleles for the disorder
N−n=the number of the least common alleles in the secondary testing subset
I=number of total individuals tested
I/2=number of couples tested
P=prevalence of the disorder in the general population, including all variations
J=number of cases identified by the process by the primary testing of the subset n or the secondary testing of the remaining alleles (N−n)
B=benefits per case identified
C=cost of testing one individual for one allele
U=number of tests conducted in the primary screen of both individuals
V=number of tests conducted in the secondary screen of only the partners of a carrier

11. The method of claim 1, further comprising:
eliminating candidates from the set of candidates based upon an unacceptable genetic compatibility score generated from the personal profiles for both the user and said candidate.

12. A method, performed by a computer, for operating a matching service, said method comprising:
maintaining a database of a one or more of candidates having personal profiles, comprising:
collecting information for a candidate related to social factors used in a personal profile;
collecting information related to genetic factors used in determination of risk said candidate producing offspring with disease for updating a personal profile for said candidate, wherein collecting information related to genetic factors by compiling information concerning a testing of DNA sample from said candidate and questionnaire directed to genetic and hereditary history for said candidate;
creating a personal profile for said candidate based upon social factors and genetic factors, wherein the information concerning genetic factors of a user or candidate is not disclosed to the user or the candidate;
comparing a personal profile of a one user with the personal profiles of said candidates in said database for social compatibility;
generating a set of candidates that are socially compatible with said user;
comparing said personal profile of said user with each of the personal profiles of said generated set of candidates;
determining risk of user producing offspring having a disease with each of said candidates within said generated set;
eliminating said candidates having unacceptable risk of user and said candidate producing offspring having a disease before user views the set of candidates; and
presenting to the user said set of candidates.
